(19) United States
(12) Patent Application Publication
(10) Pub. No.: US 2014/0251163 A1
(43) Pub. Date: Sep. 11, 2014

(54) APPARATUS FOR REDUCING THE COOKING TIME OF PRIME RIB STEAKS

(71) Applicant: WAYNE CHARLES DAVIS, Spokane, WA (US)

(72) Inventor: WAYNE CHARLES DAVIS, Spokane, WA (US)

(21) Appl. No.: 14/196,881

(22) Filed: Mar. 4, 2014

Related U.S. Application Data
(60) Provisional application No. 61/851,320, filed on Mar. 6, 2013.

(51) Int. Cl. A47J 37/06

(52) U.S. Cl. CPC A47J 37/067
USPC 99/446; 99/447

(57) ABSTRACT

A cooking apparatus for use with an oven to reduce the cooking time of sliced prime rib steaks and prevent the steaks from overcooking includes a base pan to be placed in the oven and a rising pan disposed on the base pan, the rising pan having a top sheet able to be a heating surface for the steaks and at least one insulation layer that creates a first air pocket between the top sheet and the at least one insulation layer, and a second air pocket between the at least one insulation layer and the base pan. The steaks are cooked from heat emanating from above the top sheet. The base pan and insulation layer shield the steaks from rising heat, thereby preventing the steaks from overcooking.

### RELATED APPLICATION

The application claims priority to provisional patent application U.S. Ser. No. 61/851,320 filed on Mar. 6, 2013, the entire contents of which is herein incorporated by reference.

### BACKGROUND

The embodiments herein relate generally to systems and apparatuses for cooking prime rib steaks.

Cooking prime rib steaks require significant time and attention to ensure the steak is properly cooked to a desired level, e.g., rare, medium rare, medium, medium well, well done, etc. Currently, cooks place a large slab of prime rib on a cooking pan, which is then baked and/or broiled in an oven. The cooking time for a family-sized portion typically takes at least 3 hours, while slow roast recipes may take up to 8 hours. If the cook fails to promptly remove the steak from the oven when a desired internal temperature of the meat is reached, the steak will be overcooked or undercooked. This can be especially frustrating for the cook who spends significant preparation and cooking time when the finished steak is overcooked and/or inedible.

As such, there is a need in the industry for an apparatus for reducing the time required to cook prime rib steaks while allowing one to easily achieve a desired taste and texture.

### SUMMARY

A cooking apparatus for use with an oven to reduce the cooking time of sliced prime rib steaks and prevent the steaks from overcooking is provided. The cooking apparatus comprises a base pan configured to be placed in the oven, and a rising pan disposed on the base pan, the rising pan comprising a top sheet configured to be a heating surface for the steaks and at least one insulation layer oriented parallel to the top sheet to create a first air pocket between the top sheet and the at least one insulation layer and a second air pocket between the at least one insulation layer and the base pan, wherein the steaks are cooked from heat emanating from above the top sheet, and the base pan and insulation layer shield the steaks from rising heat, thereby preventing the steaks from overcooking.

### BRIEF DESCRIPTION OF THE FIGURES

The detailed description of some embodiments of the invention will be made below with reference to the accompanying figures, wherein the figures disclose one or more embodiments of the present invention.

FIG. 1 depicts a perspective view of certain embodiments of the cooking apparatus in use;

FIG. 2 depicts a perspective view of certain embodiments of the cooking apparatus;

FIG. 3 depicts an exploded perspective view of certain embodiments of the cooking apparatus;

FIG. 4 depicts a section view of certain embodiments of the cooking apparatus taken along line 4-4 in FIG. 2; and

FIG. 5 depicts a section view of certain embodiments of the cooking apparatus taken along line 5-5 in FIG. 2.

### DETAILED DESCRIPTION OF CERTAIN EMBODIMENTS

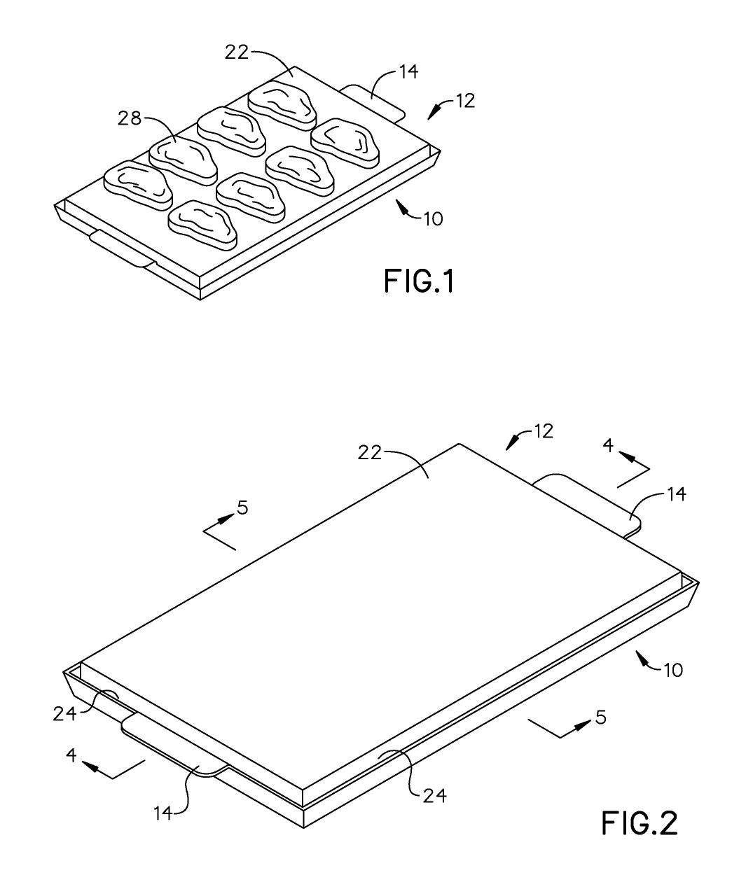

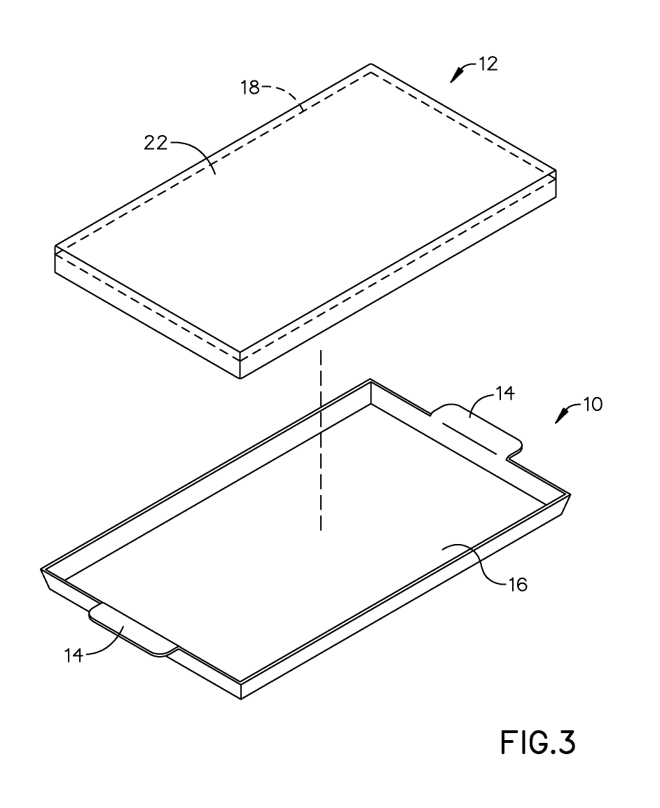

As depicted in FIGS. 1-3, the cooking apparatus comprises drip pan 10 and rising pan 12 The cooking apparatus is designed for use with steaks 28 in any type of oven (not shown) in the field. In a preferred embodiment, the apparatus is used to cook prime rib steaks. However, it shall be appreciated that the apparatus may be used to cook any types of food including, but not limited to, meat, seafood, vegetables, grains, or the like.

Drip pan 10 is rectangular and has dimensions of approximately 15½″ in length and 11¾″ in width. Drip pan 10 further comprises handles 14 and base surface 16. Rising pan 12 comprises cooking surface 22 and top insulation layer 18. Rising pan 12 is disposed within the interior of drip pan 10. This creates drip slots 24 between the edges of drip pan 10 and the edges of rising pan 12. In a preferred embodiment, rising pan 12 and drip pan 10 are made from stainless steel. However, it shall be appreciated that rising pan 12 and drip pan 10 may be made from hard anodized aluminum or any other alternative material or combination of materials.

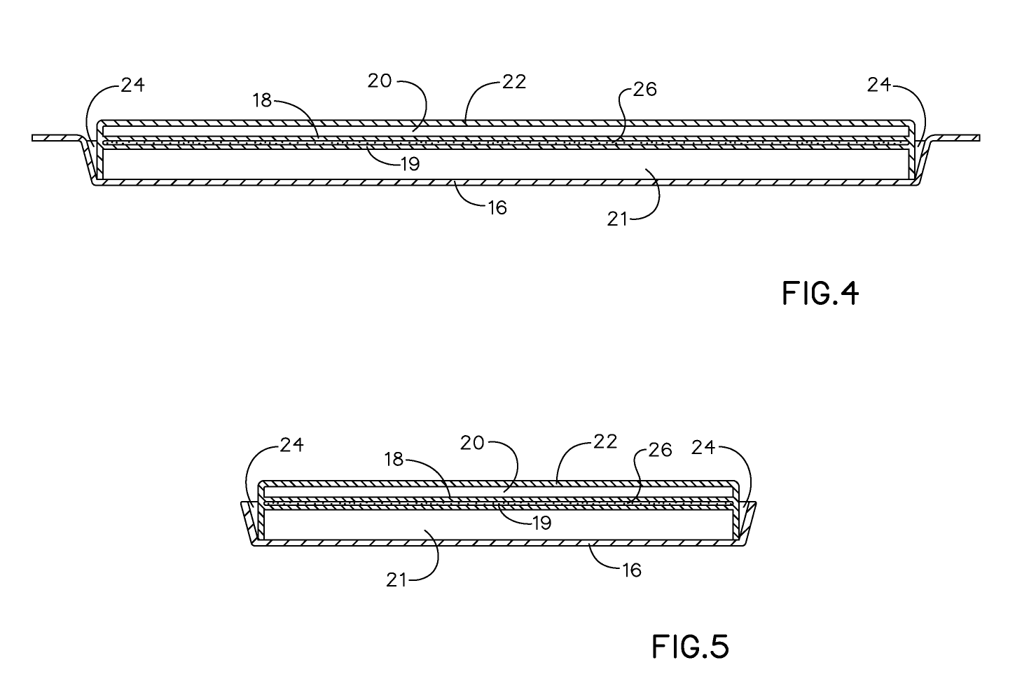

As depicted in FIGS. 4-5, rising pan 12 comprises cooking surface 22, top insulation layer 18, heat insulating material 26 and bottom insulation layer 19 oriented parallel to one another. Top insulation layer 18 and bottom insulation layer 19 are made from stainless steel or hard anodized aluminum. In a preferred embodiment, cooking surface 22 has a thickness of ¼″ and both top insulation layer 18 and bottom insulation layer 19 have a thickness of 1/16″. Heat insulating material 26 is disposed between top insulation layer 18 and bottom insulation layer 19 and may comprise any heat-resistant or flame-resistant material including, but not limited to, Nomex or Insul-Bright materials. First air pocket 20 is situated between cooking surface 22 and top insulation layer 18. Second air pocket 21 is situated between bottom insulation layer 19 and base surface 16. In a preferred embodiment, first air pocket 20 has a ¼″ height and second air pocket 21 has a ¾″ height. It shall be appreciated that heat insulating material 26 is optional and is not required for the cooking apparatus to operate.

In operation, a user places rising pan 12 on top of drip pan 10. Sliced prime rib steaks with a thickness of no less than 1-2″ thick are placed on cooking surface 22 of rising pan 12. Rising pan 12 and drip pan 10 are placed in the oven and the steak slices are baked at a temperature of approximately 400 degrees Fahrenheit and/or broiled. During the cooking process, grease from the steaks disperse on cooking surface 22 and are collected in drip slots 24. Top insulation layer 18, heat insulating material 26, bottom insulation layer 19 and base surface 16 of drip pan 10 shield steaks 28 from rising heat from the bottom of the oven. This prevents the steaks from burning and/or overcooking quickly. Heat originating from the oven top and sides is directed at the steaks to enable the cooking process. It shall be appreciated that the cooking apparatus allows a user to cook sliced prime rib steaks that are comparable in texture and quality to those cooked using traditional baking, broiling, or slow roast methods where a large slab of prime rib is cooked at once. The cooking apparatus allows the user to cook sliced prime rib steaks in approximately 10 minutes, which is significantly quicker than traditional cooking methods for large slabs of prime rib steaks. However, the cooking time may vary depending on the thickness of the steaks and the desired taste.

It shall be appreciated that the components of the cooking apparatus described in several embodiments herein may comprise any alternative known materials in the field and be of any color, size and/or dimensions. This allows the apparatus to accommodate any variety and sized ovens. It shall be appreciated that the components of the apparatus described herein may be manufactured and assembled using any known techniques in the field.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A cooking apparatus for use with an oven to reduce the cooking time of sliced prime rib steaks and prevent the steaks from overcooking, the cooking apparatus comprising:
a base pan configured to be placed in the oven; and
a rising pan disposed on the base pan, the rising pan comprising a top sheet configured to be a heating surface for the steaks and at least one insulation layer oriented parallel to the top sheet to create a first air pocket between the top sheet and the at least one insulation layer and a second air pocket between the at least one insulation layer and the base pan, wherein the steaks are cooked from heat emanating from above the top sheet, and the base pan and insulation layer shield the steaks from rising heat, thereby preventing the steaks from overcooking

2. The cooking apparatus of claim 1, wherein the at least one insulation layer comprises a first sheet and a second sheet oriented parallel to one another.

3. The cooking apparatus of claim 2, further comprising an insulating material disposed between the first sheet and the second sheet, wherein the insulating material is a heat-resistant or flame-resistant material.

4. The cooking apparatus of claim 3, wherein the base pan comprises flared edges to create spacing between the base pan edges and the rising pan to collect grease from the steaks.

5. The cooking apparatus of claim 4, wherein the base pan comprises a pair of handles coupled to opposing edges of the base pan.
